(19) United States
(12) Patent Application Publication
(10) Pub. No.: US 2015/0303576 A1
(43) Pub. Date: Oct. 22, 2015

(54) Miniaturized Patch Antenna

(71) Applicants: TAGSYS, La Ciotat (FR); ESEO, Angers Cedex 2 (FR)

(72) Inventors: Mohamed LATRACH, Angers (FR); Franck D'Annunzio, La Ciotat (FR)

(73) Assignees: ESEO, Angers Cedex 2 (FR); TAGSYS, La Ciotat (FR)

(21) Appl. No.: 14/443,871

(22) PCT Filed: Nov. 21, 2013
(86) PCT No.: PCT/IB2013/060308

§ 371 Date: May 19, 2015

Related U.S. Application Data
(60) Provisional application No. 61/729,102, filed on Nov. 21, 2012.

(51) Int. Cl. H01Q 9/04; H01Q 1/38

(52) U.S. Cl. CPC H01Q 9/0407; H01Q 1/38

(57) ABSTRACT

The present invention relates to a miniaturized patch antenna assembly in UHF frequency band. The invention is notably useful in RFID applications. The patch antenna assembly includes a multilayered dielectric substrate including at least a top layer, a middle layer and a bottom layer, an electrically conductive patch structure on the upper surface of the top layer, the patch structure having a center point located at the center of patch structure surface and a feeding point electrically coupled to a feed line, a ground plane on the lower surface of the bottom layer. The assembly can include a slot etched in the patch structure, the slot surrounding the center point of the patch structure. This slot aims to concentrate the surface current at the center of the patch structure, which allows reducing its size.

### TECHNICAL FIELD

The present invention relates to a miniaturized technique of patch antenna in UHF frequency band. It can be applied in particular, but not exclusively, in wireless communication systems in which the miniaturization of the antenna is sought without degrading its gain. The invention is notably useful in RFID applications.

### BACKGROUND OF THE INVENTION

The explosive growth of wireless communication systems has led to an increasing demand for a compact size low-cost antenna. Patch antennas have a planar structure, suitable for integration on a multilayered material. But one of the problems is its large size especially in UHF frequency bands. RFID application demands high gain compact size antenna. So it is important to design antennas with high gain but of compact size although both of them are mutually conflicting properties. Several miniaturization techniques have been identified, in particular for printed low-profile antennas. These include the use of high dielectric-constant material, the use of inverted-F configurations or the use of shorting posts. The antenna size reductions achieved by using these techniques are generally small and suffer from significantly from poor efficiency and narrow bandwidth. In addition, patch antennas directly fabricated on high dielectric-constant substrates suffer from surface-wave effects that can severally degrade the performance of the antenna. The excitation of surface waves not only contaminates the radiation pattern (containing dips near the maximum and significant sidelobes) and reduces the efficiency of the radiating element, but also can cause unwanted coupling between the active devices within the module.

The introduction of slots on the resonating patch is also a known technique for miniaturizing the patch antenna. These slots are arranged on the periphery of the patch and possibly extend towards the interior of the patch. These antennas suffer from the degradation of some characteristics, notably their gain.

### SUMMARY OF THE INVENTION

The object of the present invention is to propose a patch antenna having a reduced size while keeping the gain of the antenna substantially unchanged.

According to the invention, it is proposed to etch a slot near the centre of patch structure of the antenna, said slot surrounding the centre of the patch, in order to concentrate the surface current distribution at the centre of the patch structure and, as a result, to reduce the size of the patch structure.

Thus, the invention concerns a patch antenna assembly comprising:
a multilayered dielectric or magnetic substrate including at least a top layer, a middle layer and a bottom layer,
an electrically conductive patch structure on the upper surface of the top layer, said patch structure having a centre point located at the centre of patch structure surface and a feeding point electrically coupled to a feed line,
a ground plane on the lower surface of the bottom layer, wherein it comprises a first slot etched in the patch structure, said first slot surrounding the centre point of the patch structure.

As it will be shown in the detailed description to be followed, the presence of this first slot modifies the distribution of the currents at the surface of the patch structure and concentrates them at the centre of the patch structure. As a consequence, the area of the patch structure can be reduced without decreasing significantly the gain of the antenna.

The first slot is preferably centered on the centre point of the patch structure.

The length and the width of the first slot are determined such that the patch antenna assembly receives and/or emits signals having a desired frequency.

In another embodiment, the patch antenna further comprises a second slot etched in the patch structure, said second slot surrounding the feeding point. The function of this second slot is to improve the symmetry of the radiation pattern of the antenna compared to an axis perpendicular to the plane of the patch.

In a specific embodiment, the first slot and the second slot are distant.

In another embodiment, the first slot opens into the second slot.

In a specific embodiment, the first slot and/or the second slot is/are circular or elliptic.

In another embodiment, the first slot and/or the second slot is/are polygonal, for example rectangular or hexagonal.

In a specific embodiment, the first slot is triangular and the second one is circular.

In another embodiment, the patch antenna comprises a third slot etched in the patch structure within the area delimited by the first slot.

In another embodiment, the first slot is formed by a pair of enclosed loops with splits in them at opposite ends forming a Complementary Split-Ring Resonator.

In a specific embodiment, the middle layer is an air layer.

In a variant, the middle layer is a foam layer, said foam having a permittivity greater than 1.

In a specific embodiment, the patch antenna assembly comprises a peripheral cavity in which the multilayered substrate, the patch structure and the ground plane are present, the wall of the peripheral cavity comprising at least a metallic layer connected to the ground plane.

In a specific embodiment, the patch antenna further comprises at least one double negative metamaterial layer inside the peripheral cavity, said double negative metamaterial layers being placed above the multi-layered substrate at a predetermined non-zero distance.

In a variant, the double negative metamaterial layers are replaced by parasitic patch layers, each parasitic patch layer comprising a conductive patch and a circular slot etched in the conductive patch.

### BRIEF DESCRIPTION OF THE DRAWINGS

FIG. 1 is a perspective view of a patch antenna assembly of the prior art;

FIG. 2 is a cross sectional view of the patch antenna assembly of the FIG. 1;

FIG. 3 is a diagram illustrating the return loss of the patch antenna assembly of FIG. 1;

FIG. 4 is a diagram illustrating the radiation pattern of the patch antenna assembly of FIG. 1;

FIG. 5 is a perspective view of a patch antenna assembly according to a first embodiment of the invention;

FIG. 6 is a top view of the patch antenna assembly of FIG. 5;

FIG. 7 is a cross sectional view of the patch antenna assembly of the FIG. 5;

FIG. 8 is a diagram illustrating the return loss of the patch antenna assembly of FIG. 5;

FIG. 9 is a diagram illustrating the radiation pattern of the patch antenna assembly of FIG. 5;

FIG. 10 illustrates the surface current distribution on the patch structure of the antenna assembly of FIG. 5;

FIG. 11 is a top view of the patch antenna assembly according to a second embodiment of the invention;

FIG. 12 is an enlarged view of a detail A of the FIG. 11;

FIG. 13 is a top view of the patch antenna assembly according to a third embodiment of the invention;

FIG. 14 is a top view of the patch antenna assembly according to a fourth embodiment of the invention;

FIG. 15 is a top view of the patch antenna assembly according to a fifth embodiment of the invention;

FIG. 16 is a top view of the patch antenna assembly according to a sixth embodiment of the invention;

FIG. 17 is a top view of the patch antenna assembly according to a seventh embodiment of the invention;

FIG. 18 is a top view of the patch antenna assembly according to a eighth embodiment of the invention which a variant of the seventh embodiment;

FIG. 19 is a diagram illustrating the parameter S11 of the patch antenna assembly of FIG. 18;

FIG. 20 is a perspective view of a patch antenna assembly according to a ninth embodiment of the invention;

FIG. 21 is a cross sectional view of the patch antenna assembly of the FIG. 20;

FIG. 22 is a perspective view of a patch antenna assembly according to a tenth embodiment of the invention;

FIG. 23 is a cross sectional view of the patch antenna assembly of the FIG. 22;

FIG. 24 is a perspective view of a patch antenna assembly according to an eleventh embodiment of the invention;

FIG. 25 is an exploded perspective view of a patch antenna assembly according to an twelfth embodiment of the invention; and

FIG. 26 is an exploded perspective view of a patch antenna assembly according to a thirteenth embodiment of the invention.

### DETAILED DESCRIPTION OF PREFERRED EMBODIMENTS

The dependence of the dimensions of a patch antenna on wavelength introduces a strict limitation on the ability to reduce the physical size of an antenna while maintaining its resonant frequency. However, it is possible to reduce the physical size of an antenna by introducing reactive elements in the patch element or between the patch and the ground plane. Since the resonant frequency of an antenna is inversely proportional to its total inductance and capacitance, which includes the inductance and the capacitance of the antenna on any paths to ground. If one increases either the inductance or capacitance in the path between the patch structure and the ground plane in order to maintain the resonant frequency, the antenna's inductance or capacitance must be reduced, which can be achieved by reducing the dimension of the antenna. However, increasing capacitance narrows the useable bandwidth around the antenna resonant frequency. In contrast, increasing inductance increases bandwidth, which is more desirable. In this work we thus proposed a slotted ring to increase the reactance of the antenna and thereby miniaturize the size by keeping the gain of the antenna almost unchanged.

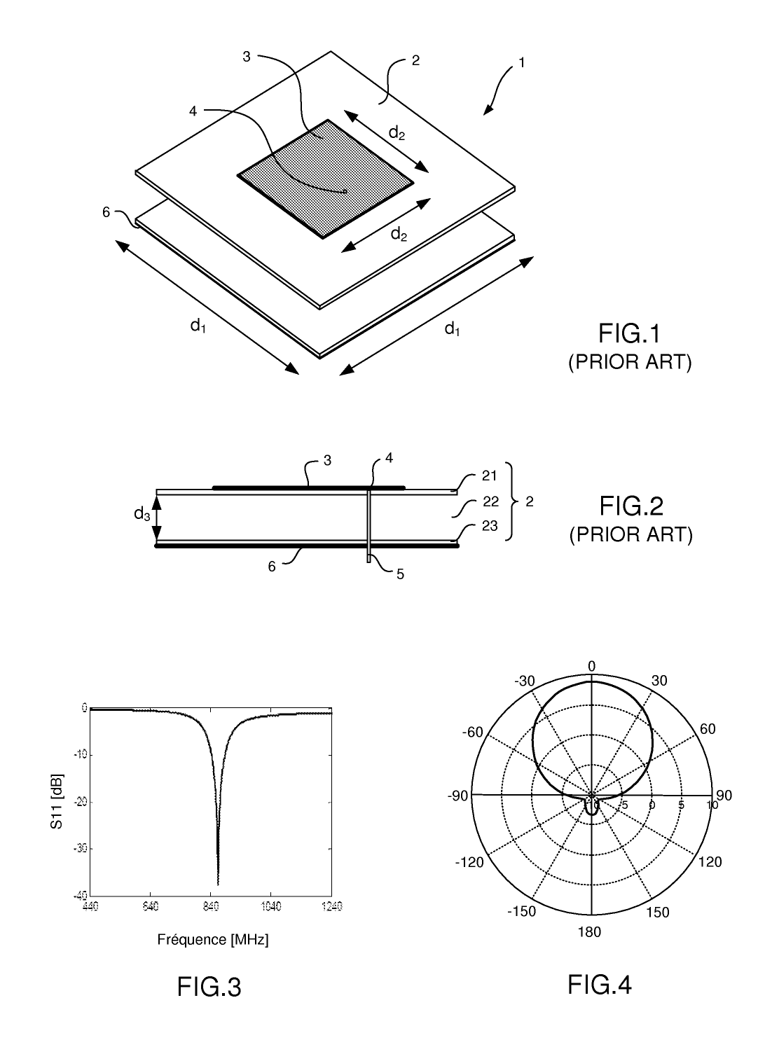

A UHF patch antenna without any slot is first described in reference to FIGS. 1 to 4. This section illustrates the size and electric parameters of a patch antenna without slot. The same parameters will be shown below for different embodiments of the patch antenna according to the invention.

In reference to FIG. 1 and FIG. 2, a patch antenna assembly 1 comprises:
a multilayered dielectric substrate 2 including at least a top layer 21, a middle layer 22 and a bottom layer 23,
an electrically conductive patch structure 3 on the upper surface of the top layer, the patch structure having a feeding point 4 electrically coupled to a feed line 5, and
a ground plane 6 on the lower surface of the bottom layer.

The multilayered substrate and the patch structure are squares. The patch size is less than the substrate size but the patch structure is centred on the top layer of the multilayered substrate. In the present case, the patch size is 14.2 cm×14.2 cm and the ground plane size is 25 cm×25 cm. d₁ designates the length of the sides of the substrate and d₂ designates the length of the sides of the patch.

The ground plane and the patch structure are made of electrically conductive material, like copper, and the top layer 21 and the bottom layer 23 are made of FR4 dielectric substrate having the following parameters:
permittivity=4.3,
loss tangent=0.021
thickness=1.6 mm.

The middle layer is an air layer having a height d₃ of 1.4 cm. So the distance between the patch antenna and the ground plane is 1.4+0.16+0.16=1.72 cm. The air gap between the top layer and the bottom layer is kept by spacers (not shown) placed at each corner of the substrate.

All these parameters of the antenna components have been defined to get the resonance at 866.3 MHz

The feeding point is located at 4 cm from the centre of the patch to get good impedance matching.

FIGS. 3 and 4 show the simulation return loss and the radiation pattern of this patch antenna assembly respectively. The simulation of this antenna was carried by using CST microwave studio simulator.

In reference to these diagrams, the patch antenna assembly of FIGS. 1 and 2 has the following features:
the simulation gain at 866.3 MHz is 8.9 dBi;
the return loss at 866.3 MHz is −49.6 dB;
the simulation voltage standing wave ratio (VSWR) at 866 MHz is 1.037; and
the −10 dB bandwidth is 49 MHz (891.5 MHz-842.5 MHz).

According to the invention, we propose to reduce the size of above-described antenna by introducing appropriate slots in the patch structure.

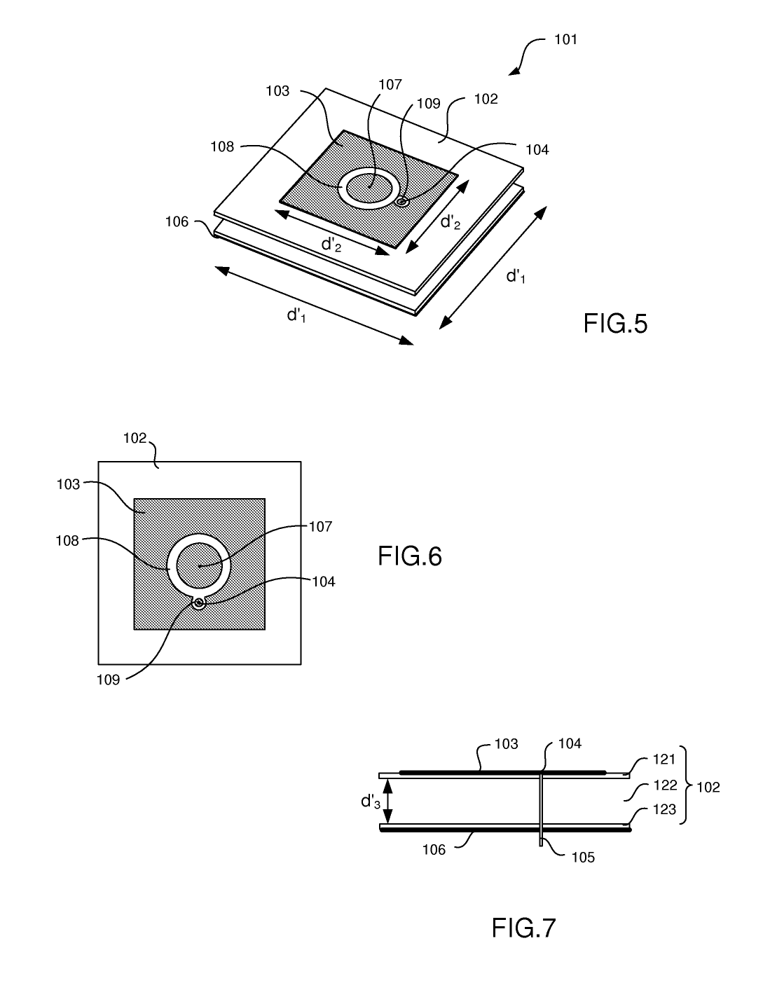

A first embodiment of the patch antenna assembly according to the invention is illustrated by FIGS. 5-10.

In this first embodiment, the patch antenna comprises two slotted rings etched in the patch structure, one surrounding the centre of the patch structure and one surrounding the feeding point.

In reference to FIGS. 5-7, the patch antenna assembly 101 according to this first embodiment comprises:
a multilayered dielectric or magnetic substrate 102 including at least a top layer 121, a middle layer 122 and a bottom layer 123,
an electrically conductive patch structure 103 on the upper surface of the top layer, the patch structure having a centre point 107 located at the centre of the patch structure a feeding point 104 electrically coupled to a feed line 105, and
a ground plane 106 on the lower surface of the bottom layer.

The top layer 121 and the bottom layer 123 are made of FR4 or other substrate type having the same parameters than the top layer 21 and the bottom layer 23 of the antenna of FIG. 1. The ground plane 106 and the patch structure 103 are made of the same electrically conductive material than the ground plane 6 and the patch structure 3 of FIG. 1 respectively.

In order to reduce the size of the patch antenna, two slotted rings are etched in the patch structure 103:
a first slotted ring, called central ring 108, surrounds the centre point 107 of the patch structure, and
a second slotted ring, called feed ring, 109 surrounds the feeding point 104.

The width and the diameter of these slotted rings can take numerous values as will be shown below. The central ring is centered on the centre point 107 and the feed ring is centered on the feeding point 104.

In this embodiment, the parameters of the antenna components are determined to get a resonant frequency at 866.3 MHz. These parameters are, for the FR4/air layers, the following ones:
width of the central ring: 0.8 cm
diameter of the central ring: 4 cm
width of the feed ring: 0.3 cm
diameter of the feed ring: 0.8 cm
position of the feeding point: 3.1 cm from the centre point 107.
patch size: 11.6 cm×11.6 cm;
ground plane size is 18 cm×18 cm.

The other parameters of the antenna remain are unchanged compared to the non-miniaturized antenna of FIG. 1.

In this first embodiment, the size of the antenna assembly 101 is reduced by 28% relative to the antenna 1.

The average perimeter of the central ring can be smaller or greater than the half-wavelength in the free space.

Indeed, the slot perimeter (respectively the radius) affects the operation frequency without the antenna gain degradation. It is therefore an essential parameter for the miniaturization.

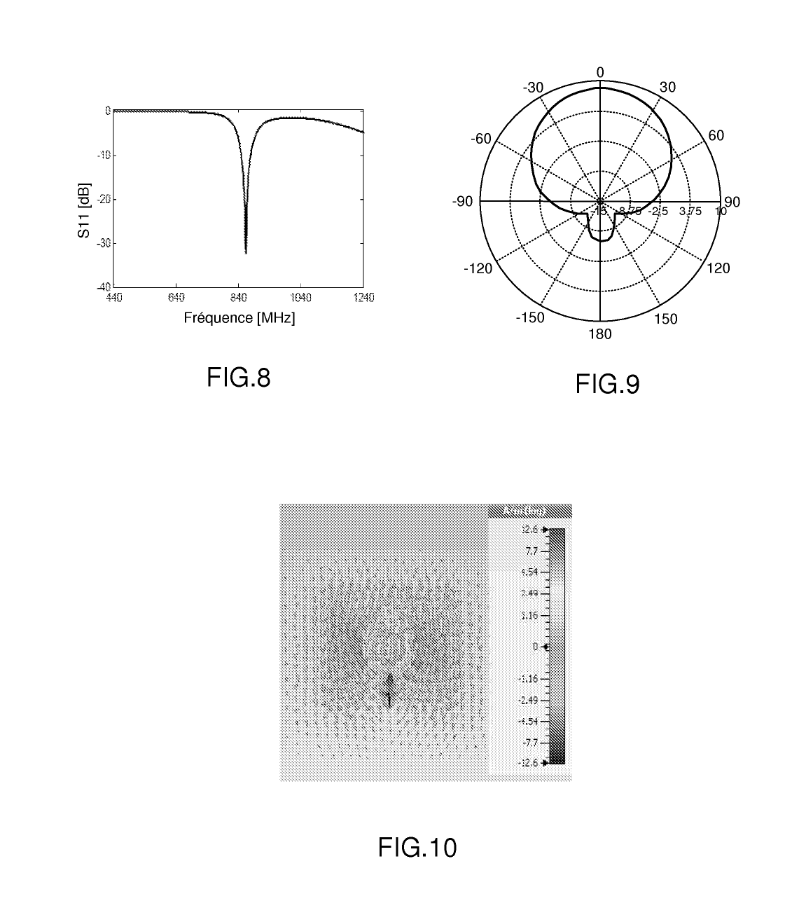

The return loss and the radiation pattern of the antenna 101 are shown in FIGS. 8 and 9 respectively. FIG. 8 shows that the antenna resonates at 866.3 MHz with a return loss of −32.35 dB. The Voltage Standing Wave Ratio (VSWR) of the patch antenna 101 is 1.04223 at the resonant frequency which indicates a good impedance matching. FIG. 9 shows that the maximum antenna gain at the resonant frequency (866.3 MHz) is 8.3 dBi. This value is slightly lower than that of the antenna 1.

These results show that the presence of the central ring 108 and the feed 109 allows reducing significantly the size of the antenna structure without degrading its gain. More specifically, the central ring 108 alone is enough to reduce the size of the antenna structure. The feed ring 109 is used to reduce the misalignment effect of the beam linked to the discontinuity between the feeding point 104 and the patch structure 103 (radiating element).

The presence of the rings 108 and 109 modifies the distribution of the surface current in the patch structure 103 as shown in the FIG. 10. As can be seen from this figure, the central ring concentrates the surface current at the centre of the patch structure, which allows to reduce the size of the effective radiating surface and, as a consequence, the size of patch structure 103. As a consequence, the size of the ground plane 106 can be reduced. As a result, the size of the antenna assembly 101 is reduced.

In this first embodiment, the central ring and the feed ring are so close that they have a common portion. The central ring opens into the feed ring or vice versa.

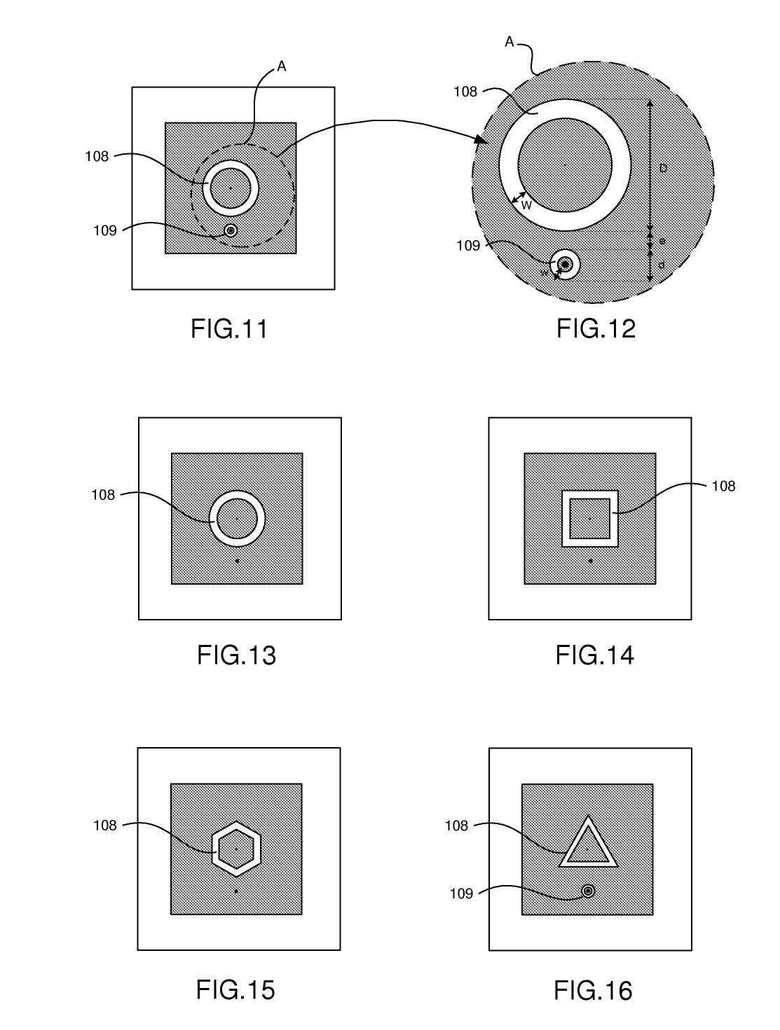

The central ring can also be moved away from the feed ring. It is illustrated by FIG. 11 and FIG. 12. In this second embodiment, the central ring and the feed ring 109 have outer diameters D and d and widths W and w, respectively and they are separated from each other by a non-zero distance e. The distance e is a function of the parameters D, d, W and w.

The resonance frequency of the antenna assembly is depending on the parameters D and W of the central ring. More specifically, the width W of the central ring has an effect on the inductance of the antenna and its diameter has an effect on the capacitance of the antenna. The width W of the central ring can vary from 2 mm to 12 mm and the diameter D from 2 cm to 4.5 cm. In the configuration of the FIGS. 5 to 7, the resonance frequency of 866.3 MHz (inside the UHF band) is obtained by a width W=8 mm and D=4 cm.

The width w and the diameter d of the feed ring have little influence on the resonance frequency.

As mentioned hereinabove, the feed ring has no influence on the size of the patch antenna. Consequently, in a third embodiment illustrated by FIG. 13, the antenna assembly does not have feed ring. The central ring alone is enough to reduce the size of the antenna structure. This central ring is not necessarily circular but may be elliptic.

The central slotted ring must concentrate the surface current at the centre of the patch structure 103. This central slot is not necessarily a ring. This slot can have different shapes as illustrated by FIGS. 14-17. This slot must surround the centre point of the patch structure 103. Preferably, this slot is centered on the centre point of the patch structure.

In FIG. 14, the central slot is a square centered on the centre point of the patch structure, in FIG. 15, the central slot is a hexagon and in FIG. 16, the central slot is a triangle. The feeding point can be surrounded by a slot 109 or not. The shape of the slot 109 is preferably circular.

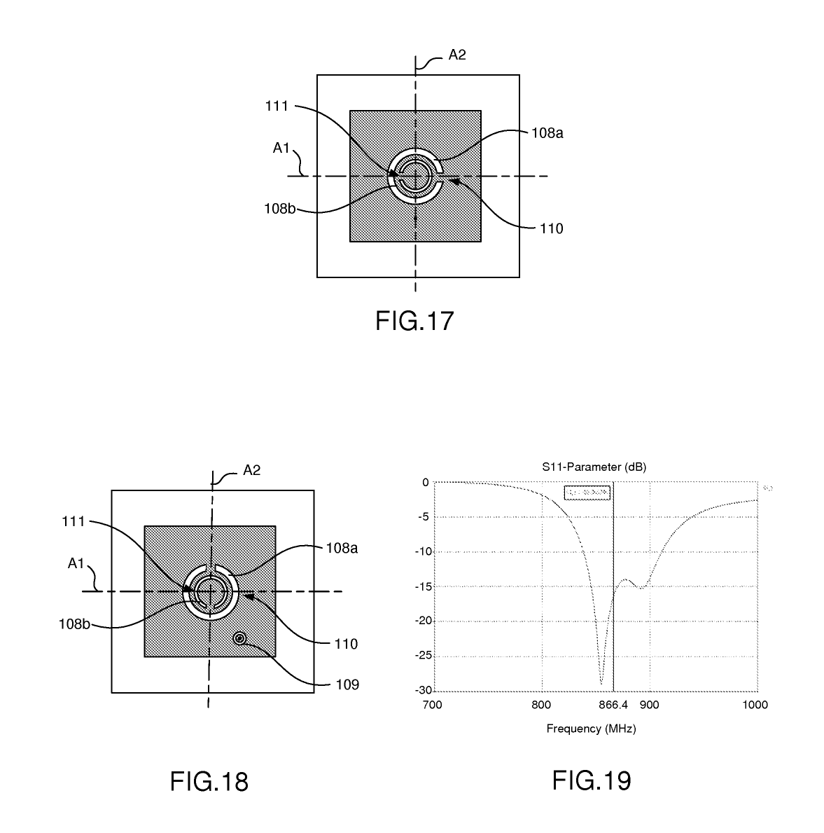

A more complex shape can be used for the central slot. As illustrated by FIG. 17, the central slot can be a cell of Complementary Split-Ring Resonator formed by a pair of enclosed loops 108a and 108b with splits 110 and 111 in them at opposite ends. The splits 110 and 111 are centered on an axis of symmetry A1 of the patch structure going through the centre point 107. The axis A1 is perpendicular to a second axis of symmetry A2 going through the centre point 107 and the feeding point 104. In this case, the antenna presents one resonant frequency. The electrical and pattern characteristics of this antenna are close to the patch antenna with a hexagonal or rectangular central slot.

If the splits 110 and 111 are centered on the axis of symmetry A2, a property of dual-band antenna is obtained. The antenna operates in dual-band by rotating around the patch centred point the cell of Complementary Split-Ring Resonator.

By centring the splits 110 and 111 on the axis of symmetry A2 and moving the feed point from this axis as illustrated by FIG. 18, both resonance dips get close thereby generating a wide frequency bandwidth as illustrated by FIG. 19.

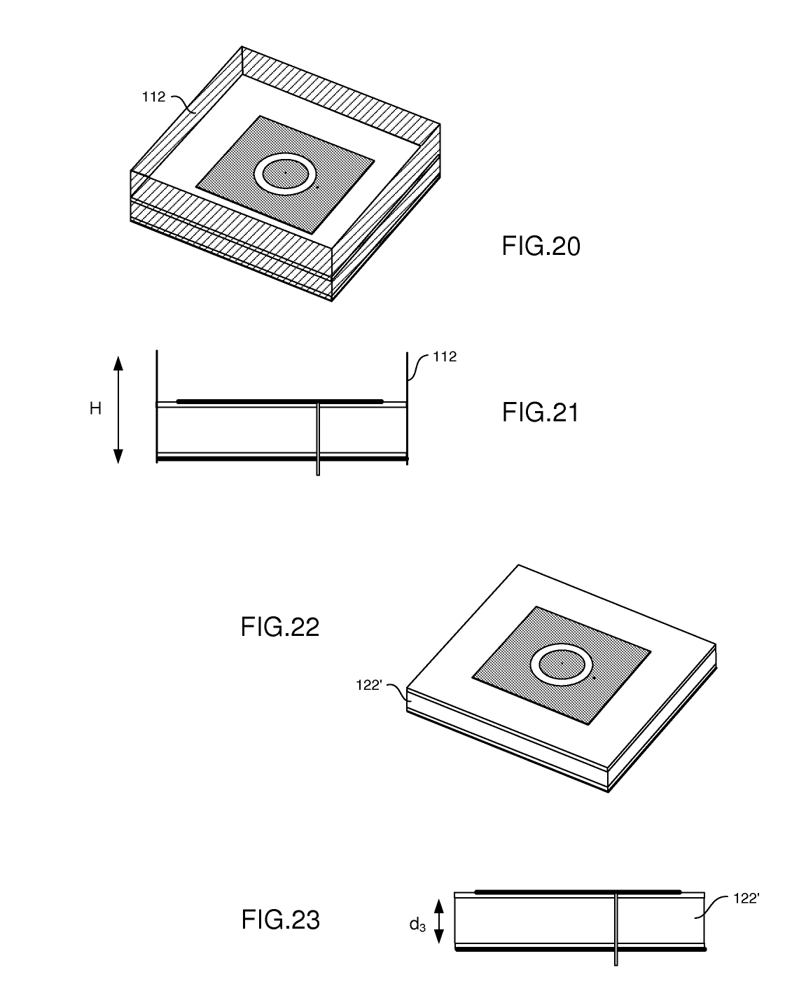

In another embodiment illustrated by FIG. 20 and FIG. 21, the patch antenna assembly is embedded in a peripheral cavity 112 having a metallic layer. This cavity comprises four vertical walls placed against the four edges of the multilayered substrate. These walls extend beyond the upper surface of the multilayered substrate and are connected to the horizontal ground plane of the patch antenna. It forms a vertical ground plane. This embodiment with a semi-open cavity allows reducing strongly the size of the patch antenna.

The walls can be metallic walls or can comprise a dielectric layer covered by a metallic layer. The height of the walls is for example 2.5 cm.

The cavity is not necessarily cube-shaped. The walls can be trapezoidal such that the cavity is an inverted pyramid. The cavity can also be cylindrical. Some of these variant shapes may contribute to improve the gain of the antenna.

In another embodiment illustrated by FIG. 22 and FIG. 23, the air layer 122 is by a foam layer 122′. This foam layer is for example a PVC layer having a permittivity greater than 1. It allows reducing the distance d₃ between the top layer and the bottom layer of the substrate. And such amendment is easier to make than a structure with an air layer requiring four spacers placed at the four corners of the substrate.

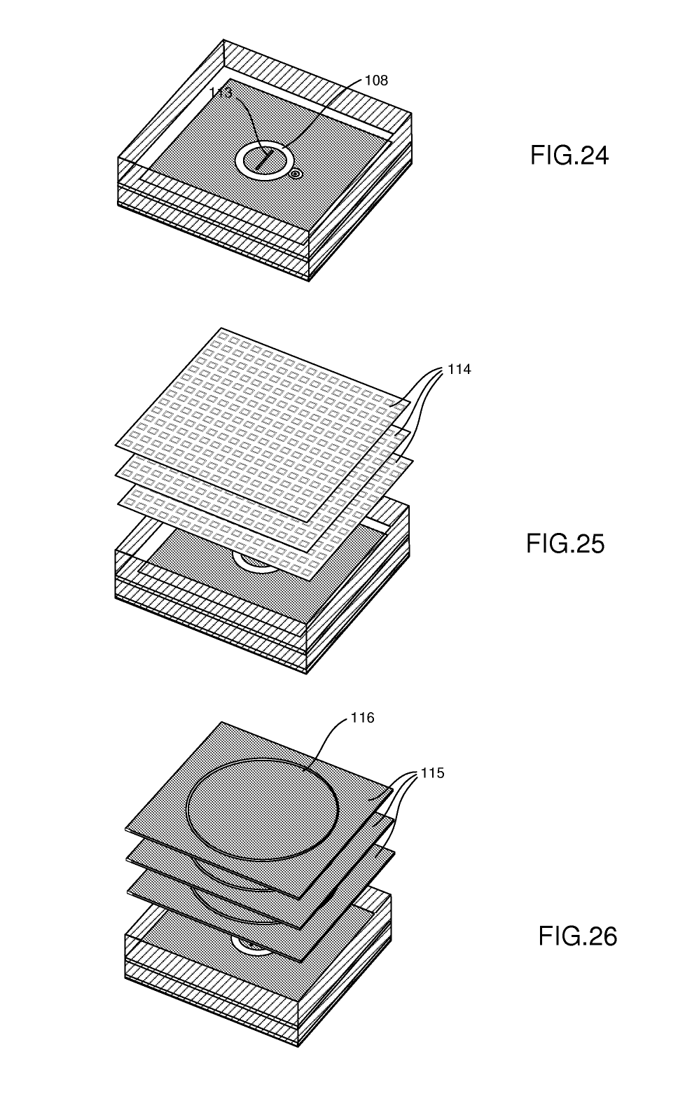

In another embodiment illustrated by FIG. 24, a third slot 113 is etched in the patch structure 103 within the area delimited by the slot 108. The slot 113 is rectilinear and placed at the centre of patch structure 103. This additional slot 113 contributes to further reduce the size of the antenna. Such a patch antenna has been simulated with the following dimensions:
the size of the patch is 10 cm×10 cm;
the size of the horizontal ground plane is 11 cm×11 cm;
the height of the vertical walls of the peripheral cavity is 2.5 cm from the horizontal ground plane;
the air gap between the patch and the horizontal ground plane is 1.4 cm;
the length of the slot 113 is 2 cm;
the diameter of the first circular slot 108 is 3 cm; and
assuming the coordinate of the patch centre is (0, 0), the coordinate of the feeding point is (0, 1.9 cm).

Such an antenna gives the following simulation results:
the simulation gain is 5.3 dBi at the resonance frequency of 866 MHz with a return loss of 22.95 dB.

In a variant, the length of the rectilinear slot 113 is equal to the inner diameter of the circular slot 108.

In order to enhance the gain of such an antenna, it is possible to add Double Negative (DNG) metamaterial layers inside the peripheral cavity. Such an embodiment is illustrated by FIG. 25. In this figure, three spaced DNG metamaterial layers 114 are present in the peripheral cavity. The distances between the DNG metamaterial layers 114 and the patch structure 103 are the following ones: the first, second and third DNG metamaterial layers 114 are placed 1 cm, 6 cm and 13 cm above the patch structure 103 respectively. In this case, the height of the peripheral cavity is 14.4 cm.

With such an arrangement, the antenna gain reaches 7.8 dBi at 887.35 MHz. The measured return loss is 19.0 dB and the S₂₁ value is −34.4 dB with lower value back radiation.

Other gain measurements have been made with different numbers of DNG metamaterial layer 114. These gain measurements are summarized in the following table:

| Square cavity-backed | Distances above the | Gain |
|---|---|---|
| antenna | patch structure | (dBi) |
| Without DNG meta layer | — | 3.5 |
| with single DNG meta layer | 12 cm | 4.5 |
| with 2 DNG meta layers | 1st at 6 cm & 2nd at 13 cm | 6.4 |
| with 3 DNG meta layers | 1st at 1 cm, 2nd at 6 cm & | 7.8 |
| | 3rd at 13 cm | |

The size of an antenna backed by a metallic cavity as defined above can be miniaturized to 11 cm×11 cm for UHF band. The measured antenna gain is 3.5 dBi without DNG metamaterial layer and 7.8 dBi with three DNG metamaterial layers as defined in the above table.

In a variant illustrated by the FIG. 26, the DNG metamaterial layers 114 are replaced by parasitic antenna layers 115. Each parasitic antenna layer 115 is a patch structure having a centred circular slot 116. This modification permits to enhance the bandwidth and the gain of the antenna. The size of the patch of each parasitic antenna layer 115 is about 10.3 cm×10.3 cm. The outer diameter of the circular slot 116 is for example 7.2 cm and its width is 2 mm.

The volume of this antenna is now 11 cm×11 cm×28.5 cm. The antenna gain is 10.9 dBi and the directivity is 12.5 dB.

Such an arrangement with parasitic antenna layers having a circular slot has the advantage of not degrading the circular polarization antenna sources. The radiation is enhanced identically in all directions.

The patch antenna according to the invention can be used for applications using ISM bands authorized in the region of operation. The embodiments described above have been defined for applications in the European ISM UHF band: 865.6 MHz-867.6 MHz

This technology of miniaturization can be used in other ISM frequency bands:
433.050 MHz-434.790 MHz;
840.5 MHz-844.5 MHz;
902 MHz-928 MHz;
952 MHz-952.6 MHz;
2.4 GHz-2.5 GHz; and
5.725 GHz-5.875 GHz.

For example, in the case of a patch antenna according to the invention working at 2.45 GHz, the size of the size of the antenna can be reduced to 5 cm×5 cm×6 cm with two parasitic antenna layers and to 5 cm×5 cm×9 cm with three parasitic antenna layers. In the latter case, the gain reaches 11.6 dBi.

Although the invention has been described in connection to different embodiments, it is to be understood that it is in no way limited thereto and that it includes all the technical equivalents of the means described as well as their combinations should these fall within the scope of the claimed invention.

1.-15. (canceled)

16. A patch antenna assembly comprising:
a multilayered dielectric or magnetic substrate including at least a top layer, a middle layer and a bottom layer;
an electrically conductive patch structure on an upper surface of the top layer, the patch structure having a center point and a feeding point electrically coupled to a feed line and distinct from the center point;
a ground plane on the lower surface of the bottom layer; and
a first slot etched in the patch structure and surrounding the center point of the patch structure, wherein the feeding point is outside an area delimited by the first slot.

17. The patch antenna according to claim 16, wherein the first slot is centered on the center point of the patch structure.

18. The patch antenna according to claim 16, wherein the patch antenna further comprises a second slot etched in the patch structure and surrounding the feeding point.

19. The patch antenna according to claim 18, wherein the first slot and the second slot are separate.

20. The patch antenna according to claim 18, wherein the first slot opens into the second slot.

21. The patch antenna according to claim 16, wherein the first slot and/or the second slot is/are circular or elliptic.

22. The patch antenna according to claim 18, wherein the first slot and/or the second slot is/are polygonal.

23. The patch antenna according to claim 18, wherein the first slot is triangular and the second slot is circular or elliptic.

24. The patch antenna according to claim 18, wherein the patch antenna further comprises a third slot that is rectilinear and etched in the patch structure within an area delimited by the first slot.

25. The patch antenna according to claim 16, wherein the first slot is formed by a pair of enclosed loops with splits in the enclosed loops at opposite ends forming a Complementary Split-Ring Resonator.

26. The patch antenna according to claim 16, wherein the middle layer is an air layer.

27. The patch antenna according to claim 16, wherein the middle layer is a foam layer, the foam having a permittivity greater than 1.

28. The patch antenna according to claim 16, wherein the patch antenna comprises a peripheral cavity in which the multilayered substrate, the patch structure, and the ground plane are present, the wall of the peripheral cavity comprising at least a metallic layer connected to the ground plane.

29. The patch antenna according to claim 28, wherein the patch antenna further comprises at least one double negative metamaterial layer inside the peripheral cavity, the at least one double negative metamaterial layer being placed above the multi-layered substrate at a predetermined non-zero distance.

30. The patch antenna according to claim 28, wherein the patch antenna further comprises at least one parasitic patch layer inside the peripheral cavity, the at least one parasitic patch layer comprising a conductive patch and a circular slot etched in the conductive patch, the at least one parasitic patch layer being placed above the multi-layered substrate at a predetermined non-zero distance.
